(19) United States
(12) Patent Application Publication
(10) Pub. No.: US 2024/0244164 A1
(43) Pub. Date: Jul. 18, 2024

(54) Information Processing Method, Information Processing Device, and Non-Transitory Computer-Readable Storage Medium Storing Program

(71) Applicant: SEIKO EPSON CORPORATION, Tokyo (JP)

(72) Inventor: Shinji KUBOTA, INA-SHI (JP)

(21) Appl. No.: 18/414,797

(22) Filed: Jan. 17, 2024

(30) Foreign Application Priority Data
Jan. 17, 2023 (JP) 2023-004816

(51) Int. Cl. H04N 9/31; G09G 3/36

(52) U.S. Cl. CPC H04N 9/3147; G09G 3/3607; H04N 9/3182; G09G 2320/0666; G09G 2320/0686; G09G 2354/00; H04N 9/3176

(57) ABSTRACT

An information processing method includes: accepting a first input indicating whether to disable or enable an adjustment function to cause a position on a projection surface of a first projection image projected by a first projector to coincide with an initial position; deciding a first area as a drawing area that is an area where an image can be drawn on a display panel provided in the first projector, when the first input indicating that the adjustment function is disabled is accepted; and deciding a second area that is smaller than the first area, as the drawing area, when the first input indicating that the adjustment function is enabled is accepted.

The present application is based on, and claims priority from JP Application Serial Number 2023-004816, filed Jan. 17, 2023, the disclosure of which is hereby incorporated by reference herein in its entirety.

### BACKGROUND

### 1. Technical Field

The present disclosure relates to an information processing method, an information processing device, and a non-transitory computer-readable storage medium storing a program.

### 2. Related Art

According to the related art, a technique of restraining a projection image projected by a projector from shifting from an initial position is proposed. For example, a projector described in JP-A-2022-92169 corrects an image on a display panel so that a projection image is projected at an initial position when the main body of the projector is moved.

The projector described in JP-A-2022-92169 includes processing of converting the coordinates of a panel image formed on the display panel and thus moving the panel image. However, in the state where the panel image is formed on the entirety of the display panel, the panel image cannot be moved. If an area where the panel image is not formed is provided on the display panel in order to secure an area to enable the movement of the panel image, a problem arises in that the entirety of the display panel cannot be used to form the panel image due to the function of correcting the projection image.

### SUMMARY

According to an aspect of the present disclosure, an information processing method includes: accepting a first input indicating whether to disable or enable an adjustment function to cause a position on a projection surface of a first projection image projected by a first projector to coincide with an initial position; deciding a first area as a drawing area that is an area where an image can be drawn on a display panel provided in the first projector, when the first input indicating that the adjustment function is disabled is accepted; and deciding a second area that is smaller than the first area, as the drawing area, when the first input indicating that the adjustment function is enabled is accepted.

According to another aspect of the present disclosure, an information processing device includes at least one processor and executes: accepting a first input indicating whether to disable or enable an adjustment function to cause a position on a projection surface of a first projection image projected by a first projector to coincide with an initial position; deciding a first area as a drawing area that is an area where the first projector can draw an image on a display panel provided in the first projector, when the first input indicating that the adjustment function is disabled is accepted; and deciding a second area that is smaller than the first area, as the drawing area, when the first input indicating that the adjustment function is enabled is accepted.

According to still another aspect of the present disclosure, a non-transitory computer-readable storage medium storing a program is provided. The program is executable by a computer and causes the computer to execute: accepting a first input indicating whether to disable or enable an adjustment function to cause a position on a projection surface of a first projection image projected by a first projector to coincide with an initial position; deciding a first area as a drawing area that is an area where the first projector can draw an image on a display panel provided in the first projector, when the first input indicating that the adjustment function is disabled is accepted; and deciding a second area that is smaller than the first area, as the drawing area, when the first input indicating that the adjustment function is enabled is accepted.

### BRIEF DESCRIPTION OF THE DRAWINGS

FIG. 1 shows an example of the configuration of a display system.

FIG. 2 is a block diagram showing an example of the configuration of a projector.

FIG. 3 is a flowchart showing an example of an operation of the projector.

FIG. 4 is a flowchart showing an example of an operation of the projector.

FIG. 5 shows a display example of a menu screen.

FIG. 6 shows another display example of the menu screen.

FIG. 7 is a schematic view showing a drawing region on a liquid crystal panel.

FIG. 8 shows an example of the display of a margin.

FIG. 9 shows another example of the display of the margin.

FIG. 10 is an explanatory view showing an initial setting of the display system.

FIG. 11 is a flowchart showing an example of an operation of the projector.

FIG. 12A is an explanatory view showing the position of the drawing region on the liquid crystal panel before adjustment processing.

FIG. 12B is an explanatory view showing the position of the drawing region on the liquid crystal panel after adjustment processing.

### DESCRIPTION OF EMBODIMENTS

An embodiment of the present disclosure will now be described with reference to the drawings.

### 1. Configuration of Display System

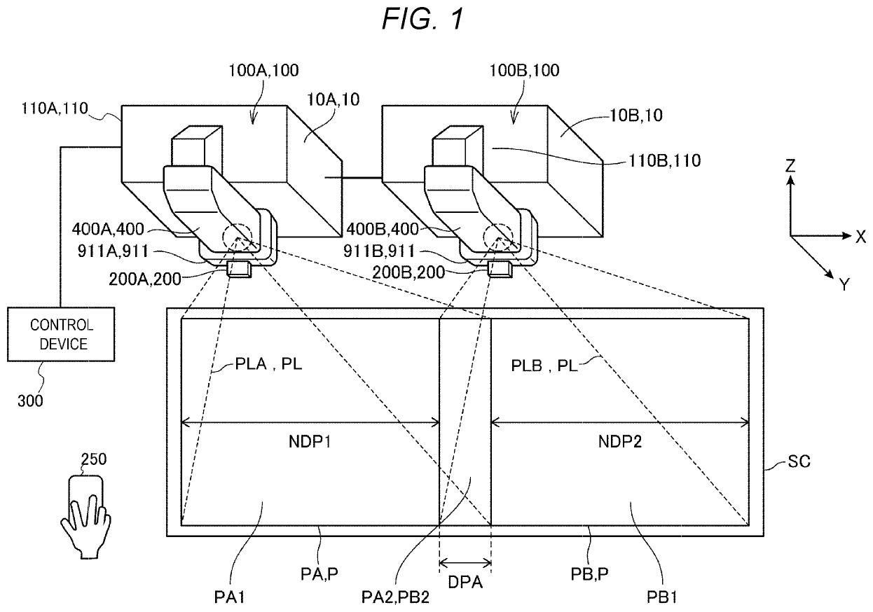

FIG. 1 shows an example of the configuration of a display system 1 according to this embodiment.

In FIG. 1, an X-axis, a Y-axis, and a Z-axis orthogonal to each other are illustrated. The Z-axis represents a vertical direction. The X-axis and the Y-axis are parallel to a horizontal direction. The X-axis represents a left-right direction. The Y-axis represents a front-back direction. A positive direction along the X-axis represents a right direction when facing a screen SC. A positive direction along the Y-axis represents a front direction when facing the screen SC. A positive direction along the Z-axis represents an upward direction.

The system according to this embodiment includes a first projector 100A, a second projector 100B, and a control device 300. The control device 300, the first projector 100A, and the second projector 100B are daisy-chained via a wire.

The first projector 100A and the second projector 100B project image light PL onto the screen SC and thus form an image on the screen SC. In the description below, the formation of an image on the screen SC by the first projector 100A and the formation of an image on the screen SC by the second projector 100B are referred to as display. The screen SC is equivalent to an example of a projection surface according to the present disclosure.

The control device 300 is connected to the first projector 100A via a wire and outputs an image signal to the first projector 100A. The first projector 100A is connected to the control device 300 and the second projector 100B via a wire and outputs the image signal inputted from the control device 300 to the second projector 100B. The control device 300 is, for example, a personal computer or a tablet terminal.

In this embodiment, an example where the control device 300, the first projector 100A, and the second projector 100B are connected via a wire is described. However, the control device 300, the first projector 100A, and the second projector 100B may be wirelessly connected. Also, a configuration where the first projector 100A and the second projector 100B are each connected to the control device 300 via a wire may be employed.

The first projector 100A operates as a primary machine. The second projector 100B operates as a secondary machine. The first projector 100A as the primary machine outputs an instruction to the second projector 100B as the secondary machine and thus controls an operation of the second projector 100B at the time of initial setting, described later.

The first projector 100A has a projector main body 10A, an optical unit 400A, and a first camera 200A. The projector main body 10A is installed, suspended from the ceiling. The optical unit 400A is installed at an installer 105A of the projector main body 10A in such a way as to be able to project image light PLA onto the screen SC. The first camera 200A is communicably coupled to the projector main body 10A and installed at an attachment 911A of the optical unit 400A in such a way as to be able to pick up an image of a first projection image PA displayed on the screen SC.

The second projector 100B has a projector main body 10B, an optical unit 400B, and a second camera 200B. The projector main body 10B is installed, suspended from the ceiling. The optical unit 400B is installed at an installer 105B of the projector main body 10B in such a way as to be able to project image light PLB onto the screen SC. The second camera 200B is communicably coupled to the projector main body 10B and installed at an attachment 911B of the optical unit 400B in such a way as to be able to pick up an image of a second projection image PB displayed on the screen SC.

The projector main body 10A extracts image data included in the image signal inputted from the control device 300 and generates the image light PLA corresponding to the extracted image data. The optical unit 400A projects the image light PLA generated by the projector main body 10A onto the screen SC. The first camera 200A picks up an image of a region of the screen SC including the first projection image PA displayed on the screen SC and thus generates a picked-up image. The generated picked-up image is used, for example, for the color adjustment of the first projection image PA.

The projector main body 10B extracts image data included in the image signal inputted from the first projector 100A and generates the image light PLB corresponding to the extracted image data. The optical unit 400B projects the image light PLB generated by the projector main body 10B onto the screen SC. The second camera 200B picks up an image of a region of the screen SC including the second projection image PB displayed on the screen SC and thus generates a picked-up image. The generated picked-up image is used, for example, for the color adjustment of the second projection image PB.

FIG. 1 shows that the first projector 100A and the second projector 100B are installed, suspended from the ceiling near a user in relation to the rectangular screen SC installed at a wall in the vertical direction. A viewer, who is the user, views an image displayed on the screen SC located below the first projector 100A and the second projector 100B.

In the system configuration shown in FIG. 1, the first projection image PA and the second projection image PB are displayed, juxtaposed in the left-right direction of the screen SC, and are thus tiled to display one large laterally long image. When tiling the first projection image PA and the second projection image PB, the first projector 100A and the second projector 100B project the image light PLA and the image light PLB in such a way that an overlap region DPA where the first projection image PA and the second projection image PB overlap each other is generated.

As shown in FIG. 1, the first projection image PA is made up of a first no-overlap image PA1 corresponding to a first no-overlap region NDP1, and a first overlap image PA2 corresponding to the overlap region DPA. The first no-overlap region NDP1 represents a region excluding the overlap region DPA, of the region corresponding to the first projection image PA. The second projection image PB is made up of a second no-overlap image PB1 corresponding to a second no-overlap region NDP2, and a second overlap image PB2 corresponding to the overlap region DPA. The second no-overlap region NDP2 represents a region excluding the overlap region DPA, of the region corresponding to the second projection image PB.

The luminance of the first overlap image PA2 is adjusted to be lower than the luminance of the first no-overlap image PA1. The luminance of the second overlap image PB2 is adjusted to be lower than the luminance of the second no-overlap image PB1. Such luminance adjustment processing in the overlap region DPA is called edge blending.

To display the first projection image PA and the second projection image PB juxtaposed in the left-right direction of the screen SC and thus tile these images to display one large laterally long image, the control device 300 supplies image data that is the source of the one large laterally long image to the first projector 100A.

The first projector 100A extracts the image data from the image signal supplied from the control device 300 and slices out image data corresponding to the range of the image to be projected by the first projector 100A according to range information. The image data of the range thus sliced out is referred to as first part image data.

The second projector 100B extracts the image data from the image signal supplied from the first projector 100A and slices out image data corresponding to the range of the image to be projected by the second projector 100B according to the range information. The image data of the range thus sliced out is referred to as second part image data.

The range information includes information representing the range where the first projector 100A projects the image and information representing the range where the second projector 100B projects the image, of the image data.

The range information is generated, for example, by an operator operating the control device 300. The generated range information is outputted from the control device 300 to the first projector 100A before the projection of the image is started. The first projector 100A outputs the range information inputted from the control device 300 to the second projector 100B.

The first projector 100A and the second projector 100B have substantially the same configuration as each other. In this embodiment, the first projector 100A and the second projector 100B are referred to as the projector 100 when not distinguished from each other. The projector main body 10A and the projector main body 10B are referred to as the projector main body 10 when not distinguished from each other. The first camera 200A and the second camera 200B are referred to as the camera 200 when not distinguished from each other. The optical unit 400A and the optical unit 400B are referred to as the optical unit 400 when not distinguished from each other. The image light PLA and the image light PLB are referred to as the image light PL when not distinguished from each other.

### 2. Configuration of Projector

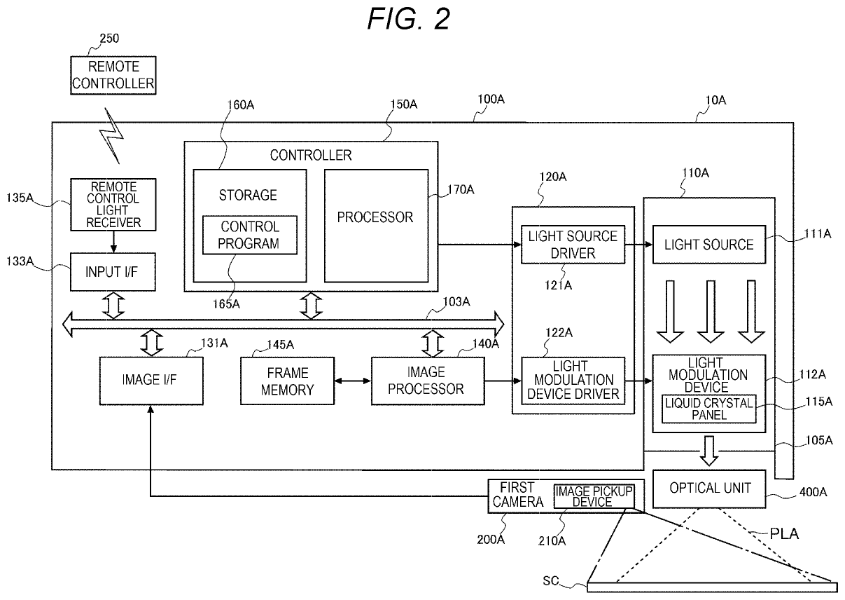

FIG. 2 shows an example of the configuration of the first projector 100A.

The first projector 100A has the projector main body 10A, the optical unit 400A, and the first camera 200A.

The projector main body 10A has a projection unit 110A, a driver 120A, an image interface 131A, an input interface 133A, a remote control light receiver 135A, an image processor 140A, a frame memory 145A, and a controller 150A. Hereinafter, the interface is abbreviated as I/F. The image I/F 131A, the input I/F 133A, the image processor 140A, and the controller 150A are coupled in such a way as to be able to communicate data with each other via a bus 103A.

The projection unit 110A has a light source 111A and a light modulation device 112A. The projection unit 110A forms an optical image and generates the image light PLA. The driver 120A has a light source driver 121A and a light modulation device driver 122A.

The light source 111A has a lamp such as a halogen lamp, a xenon lamp or an ultra-high-pressure mercury lamp, or a solid-state light source such as an LED (light-emitting diode) or a laser light source.

The light source driver 121A turns on and off the light source of the light source 111A in response to an instruction from the controller 150A.

The light modulation device 112A has a liquid crystal panel 115A that modulates light transmitted there and thus generates the image light PLA. The liquid crystal panel 115A includes a liquid crystal panel corresponding to red-color light, a liquid crystal panel corresponding to green-color light, and a liquid crystal panel corresponding to blue-color light. The light emitted from the light source 111A is separated into color lights of the three colors of red, green, and blue, which then become incident on the corresponding liquid crystal panels 115A, respectively. The image lights PLA transmitted through and modulated by the respective liquid crystal panels 115A are combined together by a light combining system such as a cross dichroic prism, and the combined light is emitted to the optical unit 400A. The liquid crystal panel 115A is equivalent to an example of a display panel according to the present disclosure.

The light modulation device driver 122A drives the light modulation device 112A. Image data corresponding to the primary colors of red, green, and blue is inputted to the light modulation device driver 122A from the image processor 140A. The light modulation device driver 122A converts the inputted image data to a data signal suitable for the operation of the liquid crystal panel 115A. The light modulation device driver 122A applies a voltage to each pixel in the liquid crystal panel 115A, based on the converted data signal, and thus draws an image on the liquid crystal panel 115A.

The optical unit 400A is installed at the installer 105A of the projector main body 10A and has a lens, a mirror, and the like, not illustrated, to cause the image light PLA generated by the projection unit 110A to form an image on the screen SC. The first camera 200A is attached to the optical unit 400A in such a way that a region including a projection image P displayed on the screen SC is the image pickup range of the first camera 200A. The optical unit 400A may have a zoom mechanism that enlarges or reduces an image projected on the screen SC, a focus adjustment mechanism that adjusts the focus, and the like.

The first camera 200A has an image pickup device 210A and is attached to the attachment 911A of the optical unit 400A. The image pickup device 210A has a lens and an image pickup element. The lens causes incident light from the image pickup range to form an image on the image pickup element. The image pickup element is made up of a CCD (charge-coupled device), a CMOS (complementary metal-oxide semiconductor) or the like and generates an image signal.

The first camera 200A, under the control of the projector main body 10A, causes the image pickup device 210A to pick up an image of the first projection image PA displayed on the screen SC, and outputs picked-up image data to the image I/F 131A of the projector main body 10A.

The image I/F 131A has a connector and an interface circuit and is connected via a wire to the control device 300 supplying image data to the first projector 100A and the first camera 200A supplying a picked-up image to the first projector 100A.

The input I/F 133A has an interface circuit and is coupled to the remote control light receiver 135A.

The remote control light receiver 135A receives an infrared signal transmitted from a remote controller 250. The input I/F 133A decodes the signal received by the remote control light receiver 135A, thus generates an operation signal, and outputs the operation signal to the controller 150A.

The frame memory 145A is a storage device having a plurality of banks. Each bank has a storage capacity in which image data of one frame can be written.

The image processor 140A loads the image data inputted from the control device 300 into the frame memory 145A. The image I/F 131A extracts image data from an image signal inputted from an external device and outputs the extracted image data to the image processor 140A.

The image processor 140A performs, for example, image processing such as resolution conversion, resizing, correction of a distortion, shape correction, digital zoom, or adjustment of the color tone or luminance of an image, on the image data loaded in the frame memory 145A.

The image processor 140A and the frame memory 145A are formed of, for example, an integrated circuit. The integrated circuit includes an LSI (large-scale integrated circuit), an ASIC (application-specific integrated circuit), a PLD (programmable logic device), an FPGA (field-programmable gate array), a SoC (system-on-a-chip) or the like. A part of the configuration of the integrated circuit may include an analog circuit. A combination of the controller 150A and an integrated circuit may be employed.

The controller 150A has a storage 160A and a processor 170A.

The storage 160A has a volatile storage device and a non-volatile storage device. The volatile storage device is formed of, for example, a RAM (random-access memory). The non-volatile storage device is formed of, for example, a ROM (read-only memory), a flash memory or an EEPROM (electrically erasable programmable read-only memory). The volatile storage device is used as an area for computation by the processor 170A. The non-volatile storage device stores a control program 165A executed by the processor 170A. The controller 150A is equivalent to an example of an information processing device and is a computer.

The processor 170A is a computational processing device having a processor such as a CPU (central processing unit) or an MPU (micro-processing unit). The processor 170A may be formed of a single processor or a plurality of processors. The processor 170A may also be formed of a SoC integrated with a part or the entirety of the storage 160A or with another circuit. The processor 170A may also be formed of a combination of a CPU executing a program and a DSP (digital signal processor) executing predetermined computational processing. Also, a configuration where all the functions of the processor 170A are installed in hardware or a configuration using a programmable device may be employed.

### 3. Operation of Display System

The first projector 100A and the second projector 100B each have a position maintenance function. The position maintenance function of the first projector 100A is a function of maintaining the position of the first projection image PA on the screen SC, at a designated position. Similarly, the position maintenance function of the second projector 100B is a function of maintaining the position of the second projection image PB on the screen SC, at a designated position. The position maintenance function is equivalent to an example of an adjustment function.

After the projector 100 is installed, the relative position or direction between the projector main body 10 and the screen SC may slightly change. Due to this change, the position of the first projection image PA and the second projection image PB on the screen SC may change. Therefore, when the position of the first projection image PA on the screen SC is changed, the first projector 100A adjusts the position of the first projection image PA to the initial position by the position maintenance function and offsets the change by this adjustment. The same applies to the second projector 100B.

The position maintenance function in this embodiment is a function of correcting the image drawn on the liquid crystal panel 115A and thus adjusting the position of the projection image P, without moving or displacing the projector main body 10 or the optical unit 400.

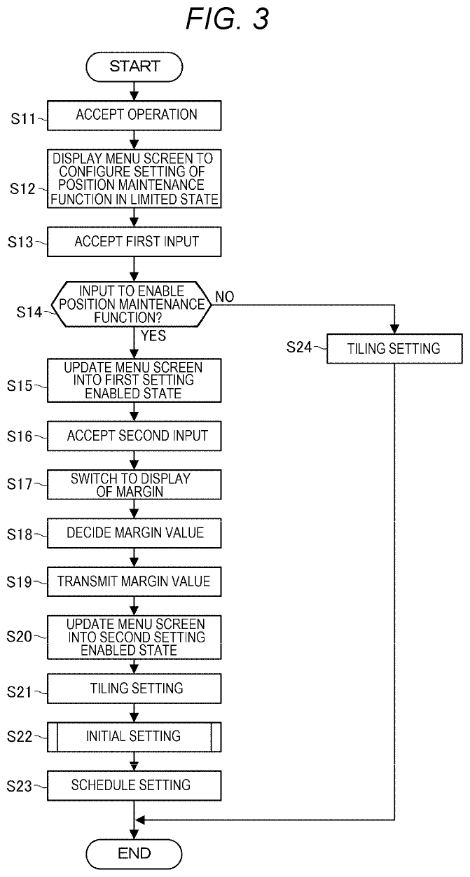

In the first projector 100A, a setting about the position maintenance function can be configured by the user operating the remote controller 250 or the like. This setting includes switching whether to enable or disable the position maintenance function. The same applies to the second projector 100B. Now, operations about the setting of the position maintenance function will be described with reference to FIGS. 3 to 9, using a case where the user operates the first projector 100A as an example.

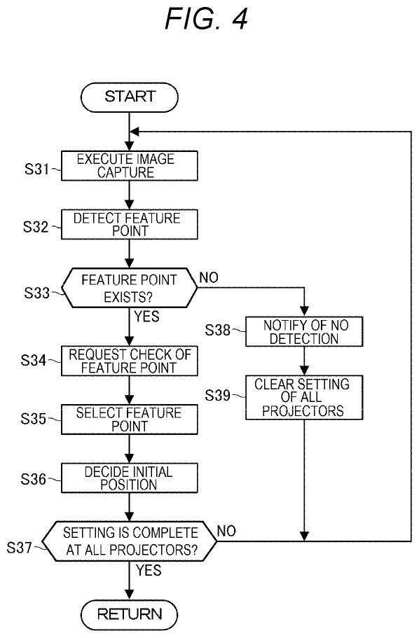

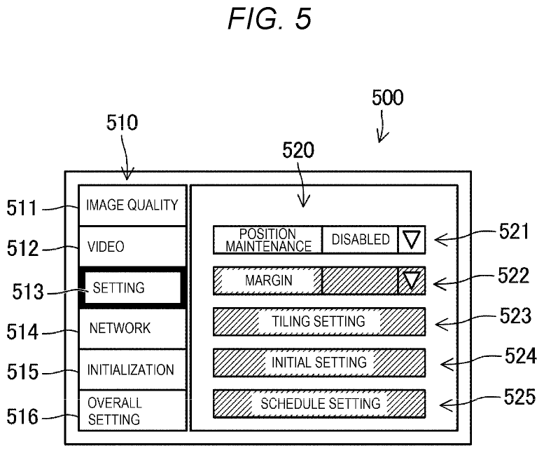

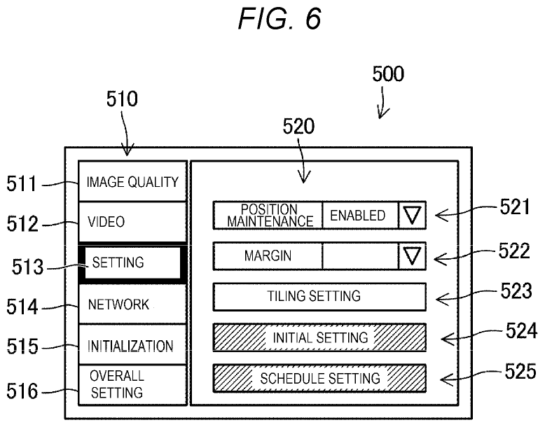

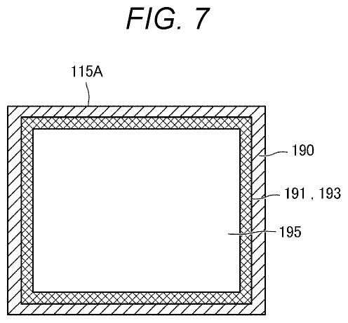

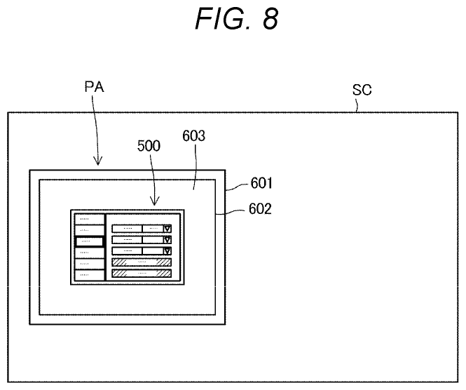

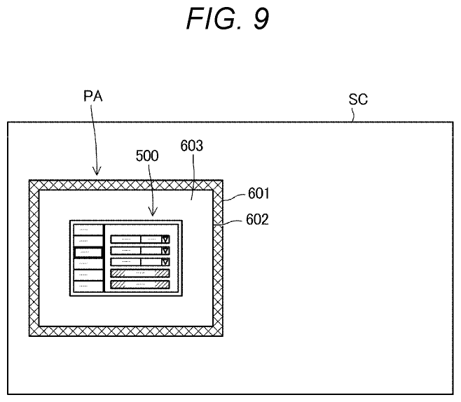

FIGS. 3 and 4 are flowcharts showing operations of the display system 1. FIGS. 5 and 6 show a display example of a menu screen. FIG. 7 is a schematic view showing a drawing region on the liquid crystal panel 115A. FIGS. 8 and 9 show an example of the display of a margin.

FIG. 3 shows the operations about the setting of the position maintenance function of the first projector 100A. The operations of steps S11 to S24 are executed by the processor 170A.

The operations shown in FIG. 3 are started in the state where a menu screen 500 is displayed by the first projector 100A. The menu screen 500 is a screen to configure a setting about the functions of the first projector 100A and is displayed, for example, in the form of an OSD (on-screen display). The processor 170A controls the image processor 140A to form display data for displaying the menu screen 500, in the frame memory 145A, and thus draws the menu screen 500 on the liquid crystal panel 115A.

The controller 150A accepts an operation to give an instruction to start the setting (step S11) and displays the menu screen 500 to configure the setting of the position maintenance function, in a limited state (step S12). A display example of the menu screen 500 displayed in step S12 is shown in FIG. 5.

As shown in FIG. 5, the menu screen 500 includes a function selector 510 and an inputter 520. In the function selector 510, items to be set via the menu screen 500 are arrayed. For example, the function selector 510 includes an image quality menu selector 511, a video menu selector 512, a setting menu selector 513, a network menu selector 514, an initialization menu selector 515, and an overall setting menu selector 516. These selectors function as operators to select setting items. As the user makes a selection via the function selector 510 by operating the remote controller 250 or the like, the setting of a function corresponding to the selected operator is started. For example, the image quality menu selector 511 corresponds to a function of setting the image quality of the first projection image PA. The video menu selector 512 corresponds to a function of setting a video displayed by the first projector 100A. The setting menu selector 513 corresponds to a function of configuring a basic setting of the first projector 100A. The network menu selector 514 corresponds to a function of configuring a communication setting of the first projector 100A. The initialization menu selector 515 is an operator to designate the initialization of the first projector 100A. The overall setting menu selector 516 corresponds to a function of configuring overall settings of the display system 1. The operation accepted by the first projector 100A in step S11 is, for example, an operation of selecting the setting menu selector 513.

In the inputter 520, an inputter and a designator to perform the input and selection of a set value are arranged for each setting item about the function selected via the function selector 510. In the example shown in FIG. 5, an inputter and a designator about the position maintenance function are arranged in the inputter 520. For example, the inputter 520 includes a position maintenance inputter 521, a margin inputter 522, a tiling setter 523, an initial setting start designator 524, and a schedule inputter 525.

The position maintenance inputter 521 is an inputter to be inputted whether to enable or disable the position maintenance function and accepts, for example, an input to select a pull-down menu. The margin inputter 522 accepts an input of the size of a margin region used for the position maintenance function. The tiling setter 523 is a designator to designate a setting of tiling by the first projector 100A and the second projector 100B. The initial setting start designator 524 is a designator to designate an initial setting of the position maintenance function. An input using the initial setting start designator 524 is equivalent to an example of a third input. The initial setting start designator 524 or the inputter 520 including the initial setting start designator 524 is equivalent to an example of a user interface that accepts the third input. The schedule inputter 525 is a designator to designate a schedule setting of the position maintenance function.

In step S12, the controller 150A displays the menu screen 500 in the limited state. The limited state refers to a state where an input or a designation of a part of the setting items is not accepted in the inputter 520, as shown in FIG. 5. In the example shown in FIG. 5, the margin inputter 522, the tiling setter 523, the initial setting start designator 524, and the schedule inputter 525 are in the state of not accepting an input or a designation.

In the menu screen 500 in the limited state, the display form of a setting item for which an input or a designation is not accepted is a limited display form in order for the user to understand that an input or a designation is not accepted. The limited display form is, for example, a form that is grayed out or filled with another color. In the menu screen 500 shown in FIG. 5, an input to disable the position maintenance function is given at the position maintenance inputter 521. The margin inputter 522, the tiling setter 523, the initial setting start designator 524, and the schedule inputter 525 are setting items about the position maintenance function. When the position maintenance function is disabled, no setting is needed. In other words, the user first gives an input to enable the position maintenance function at the position maintenance inputter 521 and subsequently gives an input or a designation via the margin inputter 522, the tiling setter 523, the initial setting start designator 524, and the schedule inputter 525, and thus can efficiently configure the settings. Displaying the menu screen 500 in the limited state has an effect of explicitly showing the order of operations to the user. Displaying the menu screen 500 in the limited state, particularly, displaying the initial setting start designator 524 in the limited state, is equivalent to an example of disabling the user interface.

The display form of the margin inputter 522, the tiling setter 523, the initial setting start designator 524, and the schedule inputter 525 in the limited state is not limited to the example shown in FIG. 5. For example, a form in which these inputters and designators are not displayed in the menu screen 500 in the limited state can also be employed. Also, the controller 150A may operate in such a way as not to accept an input to the margin inputter 522, the tiling setter 523, the initial setting start designator 524, and the schedule inputter 525 in the limited state. In this case, the display form in the limited state may be the same form as a first setting enabled state and a second setting enabled state, described later.

Referring back to FIG. 3, the controller 150A accepts a first input (step S13). In step S13, the controller 150A accepts the input in the state where the menu screen 500 is displayed. The first input is an input indicating whether to enable or disable the position maintenance function of the first projector 100A and is, for example, an operation to the position maintenance inputter 521 in FIG. 5.

The controller 150A determines whether the first input is an input to enable the position maintenance function or not (step S14). When the first input is an input to enable the position maintenance function (YES in step S14), the controller 150A updates the menu screen 500 in the limited state into the first setting enabled state (step S15).

FIG. 6 shows the menu screen 500 updated from the limited state into the first setting enabled state. In the menu screen 500 in the first setting enabled state, an input to enable the position maintenance function is given at the position maintenance inputter 521. The margin inputter 522 is displayed in the state where an input can be given. The tiling setter 523 is displayed in the state where a designation can be given. In the menu screen 500 in the first setting enabled state, the initial setting start designator 524 and the schedule inputter 525 are displayed in the state where a designation or an input cannot be given. At these designators, a designation can be given after a valid value is inputted to the margin inputter 522. The state where a designation can be given at the initial setting start designator 524 and the schedule inputter 525 is equivalent to the second setting enabled state, described later.

Referring back to FIG. 3, the controller 150A accepts a second input (step S16). The second input is an input indicating a margin value.

The margin refers to a region provided to execute the position maintenance function and not used for drawing on the liquid crystal panel 115A, of a region where the light modulation device driver 122A can draw an image on the liquid crystal panel 115A. The margin value is a value indicating the area or the size of the margin.

FIG. 7 schematically shows an example where a margin is provided on one liquid crystal panel 115A. The first projector 100A has the liquid crystal panel 115A modulating red-color light, the liquid crystal panel 115A modulating blue-color light, and the liquid crystal panel 115A modulating green-color light. A margin is similarly set on the three liquid crystal panels 115A. Therefore, one liquid crystal panel 115A is illustrated in FIG. 7.

On the liquid crystal panel 115A, a region where an image can be formed under the control of the light modulation device driver 122A is defined as a drawing available region 190. In the drawing available region 190, pixels driven by the light modulation device driver 122A are arranged and these pixels modulate the light emitted from the light source 111A.

The first projector 100A normally uses a valid region 191 provided in the drawing available region 190 for the drawing of an image, instead of using the entirety of the drawing available region 190. The entirety of an image formed in the valid region 191 is projected as the first projection image PA on the screen SC. In other words, the valid region 191 is a region available for the first projector 100A to form the first projection image PA. When the first projector 100A uses the entirety of the valid region 191 to form an image, the largest number of pixels corresponding to the first projection image PA are used and therefore it can be said that the image has the highest definition. The region that is not included in the valid region 191, of the drawing available region 190, is used, for example, for an adjustment or the like to resolve the individual variation of the first projector 100A in the manufacturing process of the first projector 100A.

When performing geometric correction, the first projector 100A uses a part of the valid region 191. When the geometric correction is performed in order to display the rectangular first projection image PA on the screen SC, an image formed by deforming a rectangle is drawn on the liquid crystal panel 115A. Therefore, the region where an image can be drawn on the liquid crystal panel 115A after the geometric correction is smaller than the valid region 191. This region is defined as an image forming region 193. In the example shown in FIG. 7, the case where the geometric correction is not performed or where the image forming region 193 can be rectangular even when the geometric correction is performed is illustrated and the valid region 191 and the image forming region 193 coincide with each other.

When executing the position maintenance function, the first projector 100A changes the position of the image drawn on the liquid crystal panel 115A in order to cause the position of the first projection image PA on the screen SC to coincide with the initial position. For example, in the state where an image is drawn in the entirety of the image forming region 193, a shift in the position of the image on the liquid crystal panel 115A causes the image to deviate from the image forming region 193. Therefore, in order to execute the position maintenance function, a region where an image is not drawn is secured in advance in preparation for a shift of the image. Thus, a smaller region than the image forming region 193 is used for drawing.

When the position maintenance function is enabled, the first projector 100A sets a drawing region 195 that is smaller than the image forming region 193. The drawing region 195 is a region where an image is formed by the light modulation device driver 122A when the position maintenance function is enabled. The region that is not included in the drawing region 195, of the image forming region 193, is the foregoing margin.

The margin value may be a value designating the size of the region to be the margin or may be a value designating the size and position of the drawing region 195. The margin value may be the number of pixels or may be the area or the rate of the number of pixels in the image forming region 193. As the unit of the rate, for example, percent (%) is used. The drawing region 195 has, for example, a similar shape to the image forming region 193. The position of the drawing region 195 in the initial state can be the center of the image forming region 193. The area of the image forming region 193 is an example of a first area. The area of the drawing region 195 is an example of a drawing area. When the position maintenance function is set to be disabled, the drawing region 195 is the entirety of the image forming region 193 and therefore the drawing area coincides with the area of the image forming region 193. That is, when the position maintenance function is set to be disabled, the first area is decided as the area of the drawing region 195. Meanwhile, when the position maintenance function is set to be enabled, a second area that is smaller than the image forming region 193 is decided as the drawing area. The margin value or the area of the image forming region 193 found based on the margin value is an example of information representing the second area. When the margin value is designated by the second input, this second input is equivalent to an example of a second input indicating the size of the second area. When the position maintenance function is enabled, an image is formed in the drawing region 195 that is smaller than the image forming region 193 on the liquid crystal panel 115A. This image is equivalent to an example of an image of the second area.

Referring back to FIG. 3, the controller 150A switches the display form of the first projection image PA to the display of the margin in response to the second input (step S17).

FIG. 8 shows an example of the display of the margin. In the example shown in FIG. 8, a maximum region frame 601, which is a frame-like image, is added to the first projection image PA including the menu screen 500 so that the user can recognize the size of the margin designated by the second input. The maximum region frame 601 represents the outer edge of the image forming region 193 shown in FIG. 7. Also, when the display of the margin is executed, a drawing region frame 602, which is a frame-like image representing the outer edge of the drawing region 195, is displayed.

During the execution of the display of the margin, the controller 150A changes the size and position of the drawing region 195 every time a margin value is inputted or changed at the margin inputter 522. The controller 150A updates the drawing region frame 602 according to the changed drawing region 195.

During the execution of the display of the margin, an image 603 including the menu screen 500 is displayed. The image 603 is drawn in the drawing region 195. Therefore, the area of the image 603 is updated along with the drawing region frame 602 every time a margin value is inputted or changed at the margin inputter 522.

In the menu screen 500 displayed during the display of the margin, an input to the margin inputter 522 can be made. Therefore, the user can change the margin value inputted at the margin inputter 522 while comparing the image 603 and the drawing region frame 602 with the maximum region frame 601.

The controller 150A may start the display of the margin before accepting the second input in step S16. In this case, in the initial state of the display of the margin, the drawing region frame 602 and the image 603 are displayed with the margin value set to be an initial value.

The form of the maximum region frame 601 and the drawing region frame 602 displayed when the display of the margin is executed may be any form that enables the user to compare the image forming region 193 with the drawing region 195 and can be changed according to need. The first projection image PA including the drawing region frame 602 is equivalent to an example of a first projection image representing an area corresponding to the second area. The maximum region frame 601 is equivalent to an example of a region display image. The drawing region frame 602 is equivalent to an image of the second area. Projecting the first projection image PA including the maximum region frame 601 onto the screen SC is equivalent to projecting a region display image representing an area corresponding to the first area onto the projection surface. Projecting the first projection image PA onto the screen SC, based on the size of the margin designated by the second input, is equivalent to projecting a first projection image representing an area corresponding to the second area onto the projection surface.

FIG. 9 shows another example of the display of the margin. In the example shown in FIG. 9, the region between the maximum region frame 601 and the drawing region frame 602 is colored. The display color of this region may preferably be a different color from the image 603 and may be the same color as the maximum region frame 601. The example shown in FIG. 9 is advantageous in that the user can easily check the area corresponding to the margin value.

The inner side of the maximum region frame 601 may be highlighted with a high-visibility color such as a fluorescent color. The drawing region frame 602 may be displayed in the same color as the image 603. Various other display forms can be employed.

During the execution of the display of the margin, the margin value inputted at the margin inputter 522 may be displayed at a different position from the menu screen 500 or enlarged and superimposed on the menu screen 500, in the image 603.

Referring back to FIG. 3, as the user performs an operation to decide the margin value inputted at the margin inputter 522, the controller 150A decides the margin value (step S18). That is, the controller 150A decides the size of the area of the drawing region 195, based on the input to the margin inputter 522. It can also be said that the second input to the margin inputter 522 is an input indicating the area where drawing is not performed on the liquid crystal panel 115A. The controller 150A transmits the margin value to the second projector 100B (step S19). The second projector 100B decides the margin value of the second projector 100B, based on the margin value transmitted from the first projector 100A. Thus, by inputting a margin value to the first projector 100A, which is the primary machine, the user can also set a margin value in the second projector 100B, which is the secondary machine. Also, the settings of the first projector 100A and the second projector 100B to perform tiling can be made consistent.

In step S17, the controller 150A may display the margin of the second projection image PB during the display of the margin of the first projection image PA or after the display of the margin of the first projection image PA is completed. In this case, the drawing region 195 is set according to the margin value on the liquid crystal panel provided in the second projector 100B, and the second projection image PB is displayed in a form showing the drawing region 195 and the image forming region 193 on the liquid crystal panel. The first projection image PA and the second projection image PB may be simultaneously displayed on the screen SC when the display of the margin is executed. Alternatively, the displayed projection image may be switched between the first projection image PA and the second projection image PB at different display timings.

Subsequently, the controller 150A updates the menu screen 500 into the second setting enabled state (step S20). The second setting enabled state is a state where a designation is enabled at the initial setting start designator 524 and the schedule inputter 525, which are displayed in a form where a designation cannot be given in the first setting enabled state. As the margin value is decided in step S18, the initial setting of the position maintenance function becomes executable. Therefore, it is appropriate to shift the menu screen 500 to the second setting enabled state.

The controller 150A configures a tiling setting in response to a designation at the tiling setter 523 (step S21). The tiling setting is a setting about the tiling of the first projection image PA and the second projection image PB and is, for example, a setting on the size of the overlap region DPA. In step S21, the setting may be automatically configured, using a captured image of the first projection image PA and the second projection image PB captured by the first camera 200A.

The controller 150A executes the initial setting in response to a designation at the initial setting start designator 524 (step S22). The initial setting in step S22 is a setting about the position maintenance function. Details of the initial setting will be described later with reference to FIG. 4.

The controller 150A configures a schedule setting, based on an input to the schedule inputter 525 (step S23). The position maintenance function may be executed periodically after the display system 1 is installed, or every time a predetermined time passes. To the initial setting start designator 524, a timing for the first projector 100A to execute an adjustment based on the position maintenance function can be inputted. Specifically, the timing may be the date and time to execute the adjustment, or the day or time interval to execute the adjustment. The time in this case may be a cumulative value of the time for which the first projector 100A is used or the time for which the first projection image PA is projected.

When the first input to the position maintenance inputter 521 is not an input to enable the position maintenance function, that is, when the first input is an input to disable the position maintenance function (NO in step S14), the controller 150A executes a tiling setting (step S24). In step S24, since the position maintenance function is disabled, the controller 150A displays the margin inputter 522, the initial setting start designator 524, and the schedule inputter 525, for example, in the display form in the limited state, and makes the margin inputter 522, the initial setting start designator 524, and the schedule inputter 525 to be in the state of not accepting an input or a designation. In step S24, the controller 150A adjusts the position of the first projection image PA and the second projection image PB.

FIG. 4 is a flowchart showing details of the initial setting in step S22.

The controller 150A causes the first camera 200A to execute image capture (step S31) and acquires a captured image. The controller 150A detects a feature point from the captured image (step S32). The feature point is a point to be a reference for the position of the first projection image PA in the captured image. The controller 150A performs feature point extraction from the captured image by a known image processing technique, thus detects a feature point included in the captured image, and specifies the coordinates in the captured image of the feature point. The feature point is, for example, a captured image of a real object or the like arranged on the screen SC. Specifically, when a marker to be a reference for the position of the first projection image PA is arranged on the screen SC or at an edge of the screen SC, an image of the marker is detected as a feature point in the captured image. The marker is a disk-like object, the frame of the screen SC, a sticker pasted on the screen SC, or the like. The marker may be arranged on the screen SC before the user configures the initial setting. When a large number of feature points are detected, such as when the image of the marker in the captured image has a predetermined size or larger, the controller 150A narrows down the feature points by a known technique.

The controller 150A determines whether there is a feature point in the captured image or not (step S33). In step S33, the controller 150A may determine whether there are a necessary number of feature points to configured the initial setting or not. When it is determined that there is a feature point (YES in step S33), the controller 150A requests the user to check the feature point (step S34). The controller 150A displays, for example, a position setting screen 530 on the screen SC and thus requests the user to check the position of the feature point.

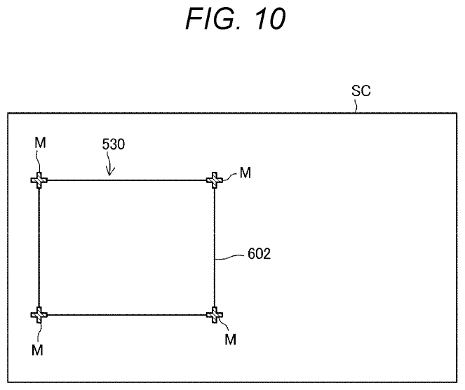

FIG. 10 is an explanatory view showing the initial setting of the display system 1 and shows the state where the position setting screen 530 is displayed on the screen SC. The position setting screen 530 is an image including the drawing region frame 602 and a pointer M. The pointer M is an image arranged according to the position of the feature point detected by the controller 150A and is formed of a geometric shape or an icon. In the position setting screen 530, for example, the menu screen 500 may be displayed on the inner side of the drawing region frame 602.

The user checks whether the position of the pointer M in the position setting screen 530 coincides with the position of the marker intended by the user or not. When the position of the pointer M differs from the user's intension, the user may cause the first projector 100A to reconfigure the initial setting.

After the position of the feature point is checked, the controller 150A selects a feature point to be used to decide the position of the first projection image PA, from among the detected feature points (step S35). Specifically, when a greater number of feature points than the necessary number are detected in step S32, the controller 150A automatically selects the necessary number of feature points. The controller 150A may also allow the user to select a feature point.

The controller 150A decides the initial position of the first projection image PA according to the positions of the feature points selected in step S35 (step S36). For example, the controller 150A converts the coordinates of the feature points in the captured image to coordinates on the liquid crystal panel 115A and defines the converted coordinates as the coordinates of the vertices of the drawing region 195. The controller 150A causes the storage 160A to store information about the decided initial position.

The controller 150A determines whether the setting is complete at all the projectors 100 that perform tiling, or not (step S37). For example, in the display system 1 shown in FIG. 1, the controller 150A determines whether the initial position is decided at both the first projector 100A and the second projector 100B or not. When the setting is complete at all the projectors 100 (YES in step S37), the controller 150A ends this processing. When the setting is not complete at all the projector 100 (NO in step S37), the controller 150A causes the projector 100 where the setting is not complete, to execute steps S31 to S37.

When it is determined in step S33 that there is no feature point (NO in step S33), the controller 150A notifies the user that no feature point is detected (step S38). The notification in step S38 is, for example, displaying a notification message by the first projector 100A. Subsequently, the controller 150A clears the setting content of the initial position of all the projectors 100 that perform tiling (step S39) and returns to step S31.

When the notification is given in step S38, the user performs an operation such as rearranging the marker on the screen SC. In this case, since the position and number of markers change, the initial position decided based on the previous markers as a reference may be not used. Therefore, the controller 150A clears the setting in step S39 and maintains the consistency between the setting content and the position of the marker.

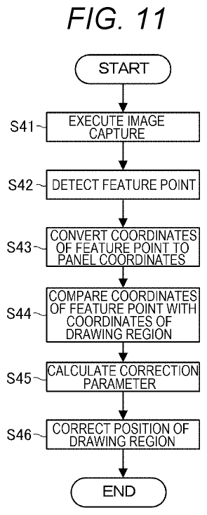

FIG. 11 is a flowchart showing an example of an operation of the projector 100 and showing adjustment processing of adjusting the position of the projection image P by the position maintenance function. The adjustment processing in the flowchart of FIG. 11 is executable by both the first projector 100A and the second projector 100B. In the description below, the case where the first projector 100A executes the adjustment processing is described as an example. Steps S41 to S46 are executed by the processor 170A. That is, the adjustment processing shown in FIG. 11 is executed by the adjustment function of the processor 170A.

The controller 150A causes the first camera 200A to execute image capture (step S41) and acquires a captured image. The controller 150A detects a feature point from the captured image (step S42). The feature point detected at this point includes the foregoing feature point of the marker.

The controller 150A converts the coordinates of the feature point in the captured image to panel coordinates, which are coordinates on the liquid crystal panel 115A (step S43).

The controller 150A compares the converted coordinates of the feature point with the coordinates of the vertices of the drawing region 195 on the liquid crystal panel 115A (step S44). In step S44, for example, the controller 150A calculates the difference between the coordinates of the feature point and the coordinates of the vertices of the drawing region 195.

The controller 150A calculates a correction parameter to correct the position of the drawing region 195 on the liquid crystal panel 115A (step S45). In step S45, the controller 150A finds a correction parameter to cause the position of the drawing region 195 to coincide with the position of the feature point, for example, based on the difference between the coordinates of the feature point and the coordinates of the vertices of the drawing region 195. The correction parameter is, for example, a projective transformation parameter to perform projective transformation of the coordinates of the drawing region 195 to coordinates based on the feature point as a reference. Using this correction parameter, not only the coordinates of the vertices of the drawing region 195 but also the coordinates of a plurality of points included in the drawing region 195 can be converted to coordinates corresponding to the feature point. The controller 150A converts the coordinates of the drawing region 195, using the correction parameter, and thus corrects the position of the drawing region 195 on the liquid crystal panel 115A to a position based on the feature point as a reference (step S46).

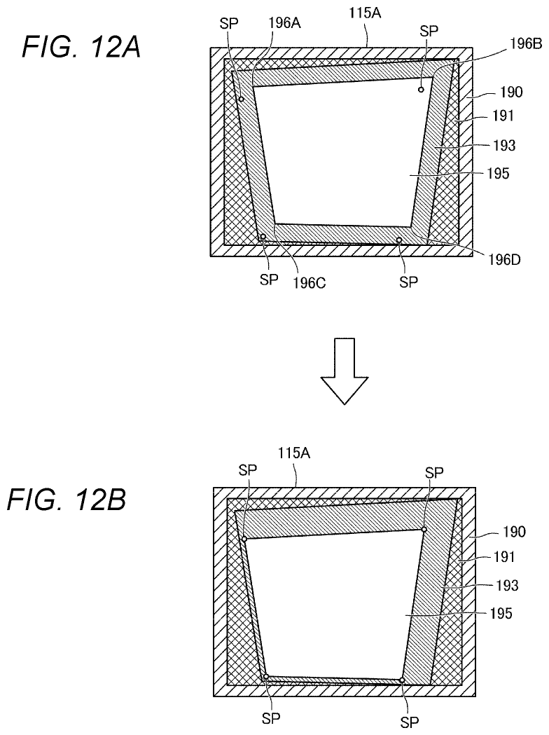

FIGS. 12A and 12B are explanatory views of the adjustment processing and show the position of the drawing region 195 on the liquid crystal panel 115A. FIG. 12A schematically shows the position of the drawing region 195, or the like, on the liquid crystal panel 115A before the adjustment processing. FIG. 12B schematically shows the position of the drawing region 195, or the like, on the liquid crystal panel 115A after the adjustment processing.

In the example shown in FIGS. 12A and 12B, the image forming region 193 arranged in the valid region 191 is an irregular quadrilateral due to geometric correction. The drawing region 195 has a similar shape to the image forming region 193. In FIG. 12A, the drawing region 195 is located at the center of the image forming region 193. In other words, the drawing region 195 is arranged in such a way that the centroid of the image forming region 193 and the centroid of the drawing region 195 coincide with each other. The area of the drawing region 195 in relation to the area of the image forming region 193 is as designated by the margin value.

In FIGS. 12A and 12B, the coordinates of a feature point on the liquid crystal panel 115A are denoted by a symbol SP. In FIG. 12A, coordinates of four vertices 196A, 196B, 196C, 196D of the drawing region 195 do not coincide with the coordinates SP of four feature points. This means that the position of the first projection image PA is shifted from the initial position.

The adjustment processing shown in FIG. 11 converts the coordinates of the drawing region 195 to the coordinates corresponding to the coordinates SP of the four feature points. Thus, the state where the coordinates of the vertices 196A, 196B, 196C, 196D coincide with the coordinates SP of the four feature points is created, as shown in FIG. 12B. On the screen SC, the image drawn in the drawing region 195 is displayed at the initial position decided in the initial setting shown in FIG. 4. This adjustment processing practically moves the drawing region 195 on the liquid crystal panel 115A and thus adjusts the position of the first projection image PA to the initial position. Therefore, even when a factor that causes the first projection image PA to shift from the initial position occurs, the projection position of the first projection image PA on the screen SC can be maintained.

In the example shown in FIGS. 12A and 12B, the image forming region 193 has a different shape from the valid region 191. However, this is an example. When the image forming region 193 does not coincide with the valid region 191 as shown in FIGS. 12A and 12B, the margin value may be a value such that the drawing region 195 has a size smaller than the area of the valid region 191. In this case, the region between the image forming region 193 and the valid region 191 can be used for drawing and therefore the image can be moved over a broader range by the position maintenance function. In other words, the region that is not the drawing region 195, in the valid region 191, can be used as the region where the image is moved by the position maintenance function, that is, as the margin. Of course, these areas can be displayed, for example, in such a way that the image forming region 193 coincides with the valid region 191, that is, the image forming region 193 is the entirety of the valid region 191.

As described above, in the display system 1 according to this embodiment, when the position maintenance function is set to be enabled, an image is projected in the image forming region 193, using the drawing region 195 smaller than the area of the image forming region 193. Thus, converting the coordinates of the drawing region 195 on the liquid crystal panel 115A can maintain the position of the first projection image PA and the second projection image PB of the projectors 100 at the initial position. When the position maintenance function is set to be disabled, an image is projected, using the drawing region 195 having the same area as the area of the image forming region 193 on the liquid crystal panel 115A. Therefore, a high-definition image can be projected on the screen SC, using a greater number of pixels in the liquid crystal panel 115A.

### 4. Other Embodiments

The foregoing embodiment is a preferred embodiment. However, the present disclosure is not limited to the foregoing embodiment and can be implemented with various modifications without departing from the spirit and scope of the present disclosure.

In the first embodiment, an example where the display system 1 has the first projector 100A and the second projector 100B and performs tiling in which the first projection image PA and the second projection image PB are arrayed in the left-right direction is described. However, the present disclosure is not limited to this embodiment. The display system 1 may perform tiling in which projection images projected by a plurality of projectors 100 are arrayed in the up-down direction. Also, tiling in the left-right direction or the up-down direction may be performed, using three or more projectors 100. So-called stacking in which two or more projectors 100 project the same image superimposed at the same position may be performed as well. The present disclosure may also be applied to a configuration where tiling is not performed, using one projector 100.

In the first embodiment, a configuration where the first projector 100A functions as a primary machine and where the second projector 100B is a secondary machine operating in accordance with the primary machine is described. However, this configuration is an example. For example, the control device 300 may execute the operations shown in FIGS. 3, 4, and 11. In this case, the control device 300 executes control to cause the projector 100 to display the menu screen 500, the position setting screen 530 or the like, processing of accepting an input to the projector 100 from a user, processing of transmitting a margin value and a correction parameter to the projector 100, and the like. The control device 300 may also perform a display equivalent to the display of the margin, on a display provided in the control device 300. The control device 300 may cause the projector 100 to execute the display of the margin. In this case, the control device 300 is equivalent to an example of an information processing device. A program for the control device 300 to execute the operations shown in FIGS. 3, 4, and 11 is equivalent to an example of a program according to the present disclosure.

In this embodiment, an example where the first projector 100A has the transmission-type liquid crystal panel 115A as a light modulation element and where the second projector 100B is similarly configured is described. However, the present disclosure is not limited to this embodiment. The light modulation element may be a reflection-type liquid crystal panel or a digital micromirror device. The number of light modulation elements is not limited to three and may be any number equal to or greater than one.

Each of the functional elements shown in FIG. 2 represents a functional configuration and is not particularly limited to any specific form of installation. That is, individual pieces of hardware corresponding respectively to the individual functional elements need not necessarily be installed. As a matter of course, a configuration where one processor executes a program and thus implements functions of a plurality of functional elements may be employed. A part of the functions implemented by software in the embodiment may be implemented by hardware and a part of the functions implemented by hardware may be implemented by software. Also, specific detailed configurations of the other parts of each of the projector 100 and the camera 200 can be changed arbitrarily without departing from the spirit and scope of the present disclosure.

### 5. Summary of Present Disclosure

A summary of the present disclosure is given below in the form of supplementary notes.

### Supplementary Note 1

An information processing method includes: accepting a first input indicating whether to disable or enable an adjustment function to cause a position on a projection surface of a first projection image projected by a first projector to coincide with an initial position; deciding a first area as a drawing area that is an area where an image can be drawn on a display panel provided in the first projector, when the first input indicating that the adjustment function is disabled is accepted; and deciding a second area that is smaller than the first area, as the drawing area, when the first input indicating that the adjustment function is enabled is accepted.

According to this method, when the first input indicating that the adjustment function is enabled is accepted, the second area is decided as the drawing area and the adjustment function can thus be executed. When the first input indicating that the adjustment function is disabled is accepted, the drawing area is made larger than the second area and a high-definition projection image can thus be projected. Thus, the projector having the adjustment function for projection image can project a projection image of higher definition.

### Supplementary Note 2

The information processing method according to Supplementary Note 1 further includes accepting a second input indicating a size of the second area when the first input indicating that the adjustment function is enabled is accepted. Deciding the second area as the drawing area includes deciding the size of the second area, based on the second input.

According to this method, the area where drawing is performed on the display panel when the adjustment function is enabled is decided, based on an input from a user. Thus, the balance between the definition of the projection image and the capability of the adjustment function when the adjustment function is used can be decided according to the user's desire.

### Supplementary Note 3

In the information processing method according to Supplementary Note 2, the second input is an input indicating an area where drawing is not performed on the display panel.

According to this method, the user can easily decide the area where drawing is not performed on the display panel when the adjustment function is enabled.

### Supplementary Note 4

In the information processing method according to one of Supplementary Notes 1 to 3, when the second area is decided, an image of the second area is drawn on the display panel and the first projection image representing an area corresponding to the second area is thus projected onto the projection surface.

According to this method the first projection image can be projected onto the projection surface in a state where the adjustment function is available.

### Supplementary Note 5

The information processing method according to one of Supplementary Notes 1 to 4 further includes drawing an image of the first area on the display panel and thus projecting a region display image representing an area corresponding to the first area onto the projection surface, when the second area is decided.

According to this method, when the adjustment function is enabled, the rate by which the drawing area is reduced for the adjustment function can be shown to the user.

### Supplementary Note 6

The information processing method according to one of Supplementary Notes 1 to 5 further includes displaying a user interface that accepts a third input to decide the initial position, and disabling the user interface until the second area is decided.

According to this method, the user can configure settings in an appropriate order, and improved convenience can be achieved.

### Supplementary Note 7

The information processing method according to one of Supplementary Notes 1 to 6 further includes transmitting information representing the second area to the first projector from an information processing device connected to the first projector.

According to this method, a setting for the adjustment function about the first projection image projected by the first projector can be configured by another device than the first projector.

### Supplementary Note 8

The information processing method according to one of Supplementary Notes 1 to 6 further includes transmitting information representing the second area from the first projector to a second projector that projects a second projection image onto the projection surface.

According to this method, the settings of a plurality of projectors can be made consistent.

### Supplementary Note 9

An information processing device includes at least one processor and executes: accepting a first input indicating whether to disable or enable an adjustment function to cause a position on a projection surface of a first projection image projected by a first projector to coincide with an initial position; deciding a first area as a drawing area that is an area where the first projector can draw an image on a display panel provided in the first projector, when the first input indicating that the adjustment function is disabled is accepted; and deciding a second area that is smaller than the first area, as the drawing area, when the first input indicating that the adjustment function is enabled is accepted.

According to this device, enabling the adjustment function and thus enabling correction of a projection image, or disabling the adjustment function and thus increasing the drawing area and projecting a high-definition projection image, can be selected according to the user's need. Thus, the projector having the adjustment function for projection image can project a projection image of higher definition.

### Supplementary Note 10

A non-transitory computer-readable storage medium storing a program is provided. The program is executable by a computer and causes the computer to execute: accepting a first input indicating whether to disable or enable an adjustment function to cause a position on a projection surface of a first projection image projected by a first projector to coincide with an initial position; deciding a first area as a drawing area that is an area where the first projector can draw an image on a display panel provided in the first projector, when the first input indicating that the adjustment function is disabled is accepted; and deciding a second area that is smaller than the first area, as the drawing area, when the first input indicating that the adjustment function is enabled is accepted.

According to this program, enabling the adjustment function and thus enabling the correction of a projection image, or disabling the adjustment function and thus increasing the drawing area and projecting a high-definition projection image, can be selected according to the user's need. Thus, the projector having the adjustment function for projection image can project a projection image of higher definition.

What is claimed is:

1. An information processing method comprising:
accepting a first input indicating whether to disable or enable an adjustment function to cause a position on a projection surface of a first projection image projected by a first projector to coincide with an initial position;
deciding a first area as a drawing area that is an area where an image can be drawn on a display panel provided in the first projector, when the first input indicating that the adjustment function is disabled is accepted; and
deciding a second area that is smaller than the first area, as the drawing area, when the first input indicating that the adjustment function is enabled is accepted.

2. The information processing method according to claim 1, further comprising:
accepting a second input indicating a size of the second area when the first input indicating that the adjustment function is enabled is accepted, wherein
the deciding the second area as the drawing area includes deciding the size of the second area, based on the second input.

3. The information processing method according to claim 2, wherein
the second input is an input indicating an area where drawing is not performed on the display panel.

4. The information processing method according to claim 1, wherein
when the second area is decided, an image of the second area is drawn on the display panel and the first projection image representing an area corresponding to the second area is thus projected onto the projection surface.

5. The information processing method according to claim 1, further comprising:
causing the first projector to draw an image of the first area on the display panel and thus causing the first projector to project a region display image representing an area corresponding to the first area onto the projection surface, when the second area is decided.

6. The information processing method according to claim 1, further comprising:
displaying a user interface that accepts a third input to decide the initial position; and
disabling the user interface until the second area is decided.

7. The information processing method according to claim 1, further comprising:
transmitting information representing the second area to the first projector from an information processing device connected to the first projector.

8. The information processing method according to claim 1, further comprising:
transmitting information representing the second area from the first projector to a second projector that projects a second projection image onto the projection surface.

9. An information processing device comprising:
at least one processor,
the information processing device executing:
accepting a first input indicating whether to disable or enable an adjustment function to cause a position on a projection surface of a first projection image projected by a first projector to coincide with an initial position;
deciding a first area as a drawing area that is an area where the first projector can draw an image on a display panel provided in the first projector, when the first input indicating that the adjustment function is disabled is accepted; and
deciding a second area that is smaller than the first area, as the drawing area, when the first input indicating that the adjustment function is enabled is accepted.

10. A non-transitory computer-readable storage medium storing a program, the program being executable by a computer,
the program causing the computer to execute:
accepting a first input indicating whether to disable or enable an adjustment function to cause a position on a projection surface of a first projection image projected by a first projector to coincide with an initial position;
deciding a first area as a drawing area that is an area where the first projector can draw an image on a display panel provided in the first projector, when the first input indicating that the adjustment function is disabled is accepted; and
deciding a second area that is smaller than the first area, as the drawing area, when the first input indicating that the adjustment function is enabled is accepted.
